(19) United States
(12) Patent Application Publication
(10) Pub. No.: US 2024/0388335 A1
(43) Pub. Date: Nov. 21, 2024

(54) Method And Apparatus For Measuring Correlation Between MIMO Antennas In Mobile Communications

(71) Applicant: MediaTek Singapore Pte. Ltd., Singapore (SG)

(72) Inventors: Deqiang Li, Beijing (CN); Aijun Cao, Linköping (SE); Yan Wu, Beijing (CN); Lingfei Fan, Beijing (CN); Jianfei Xiao, Beijing (CN); Jinxi Su, Beijing (CN)

(21) Appl. No.: 18/665,540

(22) Filed: May 15, 2024

(30) Foreign Application Priority Data
May 18, 2023 (WO) PCT/CN2023/095068
Apr. 17, 2024 (CN) 202410464944.8

(51) Int. Cl. H04B 7/0456; H04B 7/08

(52) U.S. Cl. CPC H04B 7/0456; H04B 7/0854

(57) ABSTRACT

Examples pertaining to measuring the correlation between multiple-input multiple-output (MIMO) antennas in mobile communications are described. A controller measures an over-the-air (OTA) total radiated power (TRP) associated with each of a plurality of transmit precoding matrix indicator (TPMI) indices configured for a communication apparatus to perform single-layer transmissions to obtain a plurality of TRP values each associated with a TPMI index. Each TPMI index indicates a precoding matrix for a single-layer transmission. The controller calculates an envelope correlation coefficient (ECC) between two antennas of the communication apparatus according to the TRP values.

### CROSS REFERENCE TO RELATED PATENT APPLICATION(S)

The present disclosure is part of a non-provisional application claiming the priority benefit of PCT Application No. PCT/CN2023/095068, filed 18 May 2023, and CN application Ser. No. 20/241,0464944.8, filed 17 Apr. 2024. The contents of aforementioned applications are herein incorporated by reference in their entirety.

### TECHNICAL FIELD

The present disclosure is generally related to mobile communications and, more particularly, to measuring correlation between multiple-input multiple-output (MIMO) antennas in mobile communications.

### BACKGROUND

Unless otherwise indicated herein, approaches described in this section are not prior art to the claims listed below and are not admitted as prior art by inclusion in this section.

The envelope correlation coefficient (ECC) of antennas is a parameter describing the correlation property between two coupled antennas. In a MIMO system, the ECC is a measure of the correlation between radiation patterns of a MIMO antenna pair of a user equipment (UE). Thus, the ECC can be used as a figure of merit for the capabilities of the MIMO antennas of the UE.

In conventional measurement methods for the ECC, the device under test (DUT) has to be reworked and measured passively, which is a different operating state/situation compared to that when the DUT is actively transmitting signals with two antennas simultaneously and usually leads to inaccurate ECC values. The conventional measurement methods are inefficient and inaccurate.

Accordingly, how to obtain accurate ECC values becomes an important issue for the newly developed wireless communication network. Therefore, there is a need to provide proper schemes for measuring ECC values of a DUT.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to measuring (or calculating) the correlation between MIMO antennas in mobile communications.

In one aspect, a method may involve a controller measuring an over-the-air (OTA) total radiated power (TRP) associated with each of a plurality of transmit precoding matrix indicator (TPMI) indices configured for a communication apparatus to perform single-layer transmissions to obtain a plurality of TRP values each associated with a TPMI index. Each TPMI index indicates a precoding matrix for a single-layer transmission. The method may also involve the controller calculate an envelope correlation coefficient (ECC) between two antennas of the communication apparatus according to the TRP values.

In one aspect, a test system may involve a base station simulator which, during operation, wirelessly communicates with a communication apparatus. The test system may also involve a controller communicatively coupled to the simulator such that, during operation, the controller performs following operations: indicating the simulator a plurality of transmit precoding matrix indicator (TPMI) indices to be configured for the communication apparatus to perform single-layer transmissions; instructing the whole test system to measure an over-the-air (OTA) total radiated power (TRP) associated with each of TPMI indices. The controller also performs following operations: calculating an envelope correlation coefficient (ECC) between two antennas of the communication apparatus according to the measured TRP values.

In one aspect, a method may involve a controller obtaining an envelope correlation coefficient (ECC) between two antennas of a communication apparatus and calculating a worst case two transmission (2TX) total radiated power (TRP) deviation value according to the ECC and a pair of TRP values associated with a single-antenna configuration.

It is noteworthy that, although description provided herein may be in the context

of certain radio access technologies, networks and network topologies such as 5th Generation (5G), New Radio (NR), Internet-of-Things (IoT) and Narrow Band Internet of Things (NB-IoT), Industrial Internet of Things (IIoT), 6th Generation (6G), and any radio access technologies using MIMO TPMI mechanism, the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of an OTA TRP test system in accordance with implementations of the present disclosure.

FIG. 2 is a diagram depicting a precoding matrix for single-layer transmission using two antenna ports with different TPMI indices.

FIG. 3 is a diagram depicting an example communication system having an example communication apparatus and an example network apparatus in accordance with an implementation of the present disclosure.

FIG. 4 is a diagram depicting an example process of an OTA TRP test flow in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to measuring (or calculating) the correlation between two antennas in a DUT working/operating state which is close to the scenario when the DUT is transmitting signals with two antennas. According to the present disclosure, a number of possible solutions may be implemented separately or jointly. That is, although these possible solutions may be described below separately, two or more of these possible solutions may be implemented in one combination or another.

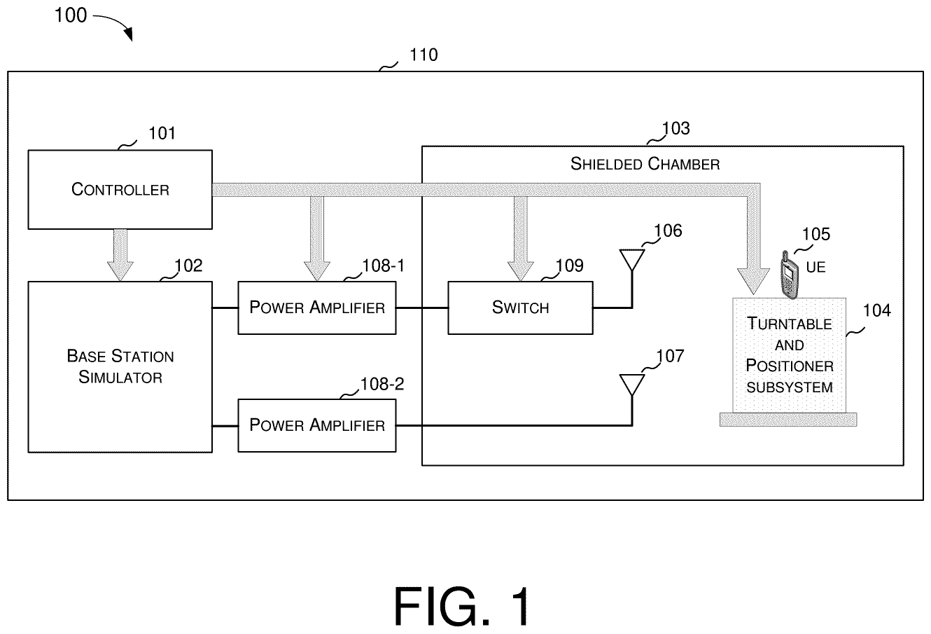

FIG. 1 illustrates an example scenario 100 of an over-the-air (OTA) total radiated power (TRP) test system in accordance with implementations of the present disclosure. The OTA TRP test system 110 may at least comprise a controller 101, a base station simulator 102, a shielded chamber 103, a tunable and positioner subsystem 104, a UE 105 (which is the DUT in the OTA TRP test system 110 and comprises at least two transmitting antennas), a series of measurement antennas 106 of two polarizations and/or different locations in the chamber, and a link antenna 107 to maintain the communication between the base station simulator 102 and the UE 105. The OTA TRP test system 110 may optionally comprise power amplifiers 108-1 and 108-2 and a radio frequency (RF) switch 109 to switch the angle of the measurement antennas 106. It should be noted that in order to clarify the concept of the invention, the OTA TRP test system 110 in FIG. 1 presents a simplified block diagram in which only the elements relevant to the invention are shown. However, the invention should not be limited to what is shown in FIG. 1.

In some implementations, the controller 101 may be implemented by a computer with an automation test tool software executed thereon and may control operations of the OTA TRP test system 110. In some implementations, the shielded chamber 103 may be an anechoic chamber (AC) or a reverberation chamber (RC) that can be used in OTA TRP measurement, but the invention is not limited thereto.

In some implementations, the controller 101 or the base station simulator 102 (e.g., under the control of the controller 101) may configure or instruct the UE 105 to transmit uplink (UL) data or signal by using different transmit precoding matrix indicator (TPMI) indices in 1-layer-2-port (i.e., single-layer transmission using two antenna ports) UL-MIMO mode codebook, to introduce different additional phase differences between the two transmitting antennas.

It can be proved that the OTA TRP values with two antennas transmitting simultaneously have close relation with the correlation between the two antennas and the phase differences corresponding to different TPMI indices.

In some implementations, the TRP may be derived from the equivalent isotropic radiated power (EIRP) as the following equation Eq. (1):

$$T R P = \frac{1}{4 π} {\int }_{0}^{2 π} {\int }_{0}^{π} EIRP ( θ , φ ) sin θ d θ d φ \qquad Eq . ( 1 )$$

$$EIRP ( θ , φ ) = \vert \vec{G} ( θ , φ ) {\vert}^{2} \qquad Eq . ( 2 )$$

where the θ and φ are respectively the elevation angle and the azimuth angle of the radiation pattern. The [symbol] (θ, φ) is the complex vector signal value radiated from an antenna whose square of amplitude is scaled to EIRP(θ, φ).

Defining that [symbol] ₁(θ, φ) and [symbol] ₂(θ, φ) are complex vector signal values respectively radiated from a first antenna and a second antenna of a UE, the initial phase difference between the patterns of the two antennas may be derived as the following equation Eq. (3):

$$α ( θ , φ ) = angle ( {\vec{G}}_{2} ( θ , φ ) ) - angle ( {\vec{G}}_{1} ( θ , φ ) ) \qquad Eq . ( 3 )$$

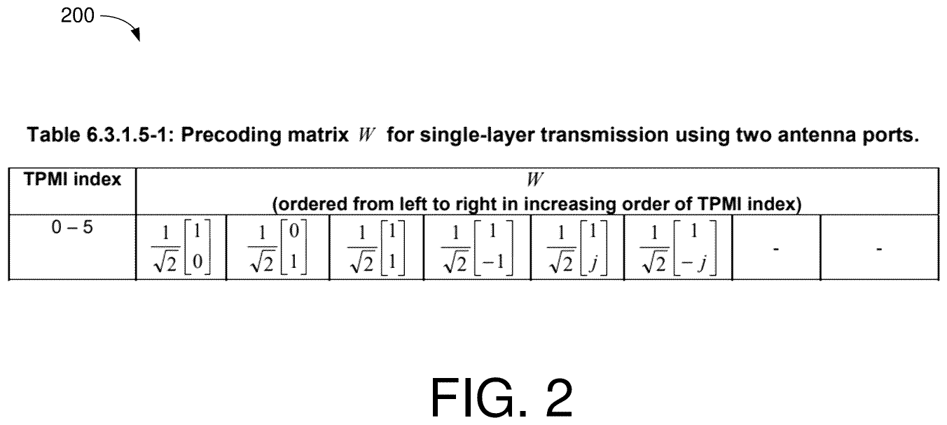

FIG. 2 illustrates a precoding matrix W for single-layer transmission using two antenna ports with different TPMI indices as defined in the 3rd generation partnership project (3GPP) specification TS 38.211, Table 6.3.1.5-1.

In some implementations, by applying the precoding matrix with different TPMI indices, different additional phase differences between two antenna ports are introduced. For example, the TPMI index 2 corresponds to a 0° phase difference, the TPMI index 3 corresponds to a 180° phase difference, the TPMI index 4 corresponds to a 90° phase difference and the TPMI index 5 corresponds to a −90° phase difference. In addition, the TPMI index 0 and 1 respectively correspond to a single-antenna configuration.

Defining that 60 ′(θ, φ) as the final phase difference between the patterns of the two antennas after applying the precoding matrix, the final phase difference may be equal to a summation of the initial phase difference and the phase difference introduced by the precoding matrix as the following equation Eq. (4):

$${α}^{′} ( θ , φ ) = α ( θ , φ ) + 0 ° / 180 ° / 90 ° / - 90 ° \qquad Eq . ( 4 )$$

where the Eq. (4) respectively introduce the phase difference for the cases when the TPMI index=2, the TPMI index=3, the TPMI index=4 and the TPMI index=5.

In some implementations, the EIRP of a 2-antenna array (e.g., the two transmission (2TX) case) may be written as the following equation Eq. (5):

$${EIRP ( θ , φ )}_{2 TX} = \vert {\vec{G}}_{1} ( θ , φ ) + {\vec{G}}_{2} ( θ , φ ) {\vert}^{2} \qquad Eq . ( 5 )$$

$$= ( {\vec{G}}_{1} ( θ , φ ) + {\vec{G}}_{2} ( θ , φ ) ) ⋆ {( {\vec{G}}_{1} ( θ , φ ) + {\vec{G}}_{2} ( θ , φ ) )}^{⋆}$$

$$= \vert {\vec{G}}_{1} ( θ , φ ) {\vert}^{2} + \vert {\vec{G}}_{2} ( θ , φ ) {\vert}^{2} + 2 \vert {\vec{G}}_{1} ( θ , φ ) \vert \vert {\vec{G}}_{2} ( θ , φ ) \vert ⋆ cos {α}^{′} ( θ , φ )$$

From the equations Eq. (1) and Eq. (5), the total TRP of the two antennas may be expressed as the following equation Eq. (6):

$$TR {P}_{2 TX} = T R {P}_{0} + T R {P}_{1} + \frac{1}{4 π} {\int }_{0}^{2 π} {\int }_{0}^{π} 2 \vert \text{} {\vec{G}}_{1} ( θ , φ ) \vert \vert {\vec{G}}_{2} ( θ , φ ) \vert * cos {α}^{′} ( θ , φ ) sin θ d θ d φ \qquad Eq . ( 6 )$$

where TRPi (i=0,1) corresponds to the TRP value of each antenna inside the 2-antenna array and also corresponds to the TRP values with the TPMI index=0 and the TPMI index=1 (i.e., with the aforementioned single-antenna configuration). The TRP2Tx may be defined as the cases TRPi (i=2,3, 4 and 5) and corresponds to the TRP values with the TPMI index=2, the TPMI index=3, the TPMI index=4 and the TPMI index=5.

Note that the α′(θ, φ) in equation Eq. (6) may be associated with a TPMI index. As an example, for the case when the TPMI index=2, α′(θ, φ)=α(θ, φ)+0°, and for the case when the TPMI index=3, ′(θ, φ)=α(θ, φ)+180°. Accordingly, the TRP₂ and TRP₃ may be respectively written as the following equations Eq. (7) and Eq. (8):

$$TR {P}_{2} = T R {P}_{0} + T R {P}_{1} + \frac{2}{4 π} {\int }_{0}^{2 π} {\int }_{0}^{π} 2 \vert \text{} {\vec{G}}_{1} ( θ , φ ) \vert \vert {\vec{G}}_{2} ( θ , φ ) \vert * cos α ( θ , φ ) sin θ d θ d φ \qquad Eq . ( 7 )$$

$$TR {P}_{3} = T R {P}_{0} + T R {P}_{1} + \frac{2}{4 π} {\int }_{0}^{2 π} {\int }_{0}^{π} 2 \vert \text{} {\vec{G}}_{1} ( θ , φ ) \vert \vert {\vec{G}}_{2} ( θ , φ ) \vert * cos α ( θ , φ ) sin θ d θ d φ \qquad Eq . ( 8 )$$

In some implementations, by performing different types of combination, such as an add operation and a subtract operation, on the TRP values to combine them in different ways, the variation part and the common part of the TRP values may be obtained as the following equations Eq. (9) and Eq. (10):

$$( TR {P}_{2} - T R {P}_{3} ) / 4 = \frac{1}{4 π} {\int }_{0}^{2 π} {\int }_{0}^{π} \vert {\vec{G}}_{1} ( θ , φ ) \vert \vert {\vec{G}}_{2} ( θ , φ ) \vert * cos α ( θ , φ ) sin θ d θ d φ \qquad Eq . ( 09 )$$

$${TRP}_{A V G ( 2 , 3 )} = ( T R {P}_{2} + T R {P}_{3} ) / 2 = T R {P}_{0} + {TRP}_{1} \qquad Eq . ( 10 )$$

where (2, 3) may be a pair of TPMI indices with a 180 degree, and TRP_{AVG(2,3)} represents the average of the TRP values with the TPMI index=2 and the TPMI index=3.

Similarly, by performing different types of combination, such as an add operation and a subtract operation, on the TRP values to combine them in different ways, the variation part and the common part of the TRP values may be obtained as the following equations Eq. (11) and Eq. (12):

$$( TR {P}_{4} - T R {P}_{5} ) / 4 = \frac{1}{4 π} {\int }_{0}^{2 π} {\int }_{0}^{π} \vert {\vec{G}}_{1} ( θ , φ ) \vert \vert {\vec{G}}_{2} ( θ , φ ) \vert * sin α ( θ , φ ) sin θ d θ d φ \qquad Eq . ( 11 )$$

$${TRP}_{A V G ( 4 , 5 )} = ( T R {P}_{4} + T R {P}_{5} ) / 2 = T R {P}_{0} + T R {P}_{1} \qquad Eq . ( 12 )$$

where (4, 5) may be another pair of TPMI indices with a 180 degree, and TRP_{AVG(4,5)} represents the average of the TRP values with the TPMI index=4 and the TPMI index=5.

In some implementations, the average of the TRP2Tx values may be obtained as the following equation Eq. (13):

$$T R {P}_{A VG ( 2 , 3 , 4 , 5 )} = ( T R {P}_{AVG ( 2 , 3 )} + T R {P}_{AVG ( 4 , 5 )} ) / 2 = T R {P}_{0} + T R {P}_{1} \qquad Eq . ( 13 )$$

The ECC between two antennas may be defined as the following equation Eq. (14):

$$ρ = \frac{\vert \int {\int }_{4 π} {\vec{G}}_{1} \cdot {{\vec{G}}_{2}}^{⋆} d Ω \vert}{\sqrt{\int {\int }_{4 π} {\vec{G}}_{1} \cdot {{\vec{G}}_{1}}^{⋆} d Ω \int {\int }_{4 π} {\vec{G}}_{2} \cdot {{\vec{G}}_{2}}^{⋆} d Ω}} \qquad Eq . ( 14 )$$

where [symbol] ₁ is a shortened form of [symbol] ₁(θ, φ) and [symbol] ₂ is a shortened form of [symbol] ₂(θ, φ).

In some implementations, from the equations Eq. (1), Eq. (3) and Eq. (14), the equation Eq. (15) is derived as follows:

$$ρ * \sqrt{T R {P}_{0} * T R {P}_{1}} = \vert \frac{1}{4 π} {\int }_{0}^{2 π} {\int }_{0}^{π} {\vec{G}}_{1} \cdot {{\vec{G}}_{2}}^{⋆} sin θ d θ d φ \vert \qquad Eq . ( 15 )$$

$$= \vert \frac{1}{4 π} {\int }_{0}^{2 π} {\int }_{0}^{π} \vert {\vec{G}}_{1} \vert \vert {\vec{G}}_{2} \vert * {e}^{- a ( θ , φ )} sin θ d θ d φ \vert$$

$$= \vert \frac{1}{4 π} {\int }_{0}^{2 π} {\int }_{0}^{π} \vert {\vec{G}}_{1} \vert \vert {\vec{G}}_{2} \vert * cos α ( θ , φ ) sin θ d θ d φ$$

$$- \frac{j}{4 π} {\int }_{0}^{2 π} {\int }_{0}^{π} \vert {\vec{G}}_{1} \vert \vert {\vec{G}}_{2} \vert * sin α ( θ , φ ) sin θ d θ d φ \vert$$

From the equations Eq. (9), Eq. (11) and Eq. (15), the equation Eq. (16) which may be utilized for calculating the ECC is derived as follows:

$$ρ = \sqrt{{( ( T R {P}_{2} - T R {P}_{3} ) / 4 )}^{2} + {( ( T R {P}_{4} - T R {P}_{5} ) / 4 )}^{2}} / \sqrt{T R {P}_{0} * T R {P}_{1}} \qquad Eq . ( 16 )$$

In some implementations, based on the equation Eq. (16), the ECC, which is a measure of the correlation between the MIMO antennas, may be determined or calculated based on the measured TRP values TRP₀˜TRP₅.

In addition, some implementations, when there is no deviation to the average of the TRP values TRP₄ and TRP₅, the equation Eq. (17) is derived as follows:

$$T R {P}_{4} = T R {P}_{5} = T R {P}_{A V G ( 4 , 5 )} = T R {P}_{0} + T R {P}_{1} \qquad Eq . ( 17 )$$

Under the condition described by Eq. (17), all the TRP deviation effects led to by antenna correlation effect are completely imposed on the TRP deviation of TRP₂ and TRP₃ as can be seen in Eq. (16), that is, the worst-case TRP deviation on TRP₂ and TRP₃ happens.

In an event that the ECC value is known, the worst case of 2TX deviation value for TRP₂ and TRP₃ may be derived from the equations Eq. (16) and Eq. (17) as follows:

$$T R {P}_{E R R ( 2 , 3 )} = \vert T R {P}_{2} - T R {P}_{A V G ( 2 , 3 )} \vert = \vert T R {P}_{3} - T R {P}_{A V G ( 2 , 3 )} \vert = \vert T R {P}_{2} - T R {P}_{3} \vert / 2 = 2 * ρ * \sqrt{T R {P}_{0} * T R {P}_{1}} \qquad Eq . ( 18 )$$

where TRP_{ERR(2,3)} represents the deviation value of the TRP values with the TPMI index=2 and the TPMI index=3.

Specially, when TRP₀≈TRP₁, the approximation is obtained as the following equation Eq. (19):

$$T R {P}_{E RR ( 2 , 3 )} \approx ρ * ( T R {P}_{0} + T R {P}_{1} ) \qquad Eq . ( 19 )$$

In some implementations, as expressed in the equation Eq. (6), for each 2TX TRP value when TPMI index=2 to 5, the corresponding TRP value comprises two parts, wherein a first part is a summation of the TRP values of the two single antennas and is a fixed average value if the antenna array design is fixed, and a second part contains the component of phase difference between two antennas, which is related to the antenna design and may be affected by many factors and may hardly be predicted either. Thus, the 2TX TRP value with specific TPMI index is randomized, leading to a fact that the 2TX TRP value could be higher or lower than the average value for some deviation value.

In addition, in some implementations, the TRP values with different TPMI indices may be averaged to remove randomness or the variation part and keep the common part, which is equal to the sum of the TRP values of the two single antennas as shown in the derivation of the equations Eq. (10), Eq. (12) and Eq. (13).

In addition, as shown in the equation Eq. (16), the ECC value has a direct relation with the TRP values corresponding to the six 1-layer 2-port TPMI indices. Therefore, the ECC value may be measured, calculated or determined by the six TRP values that can be measured in the OTA TRP test system 110.

In addition, in some implementations, as shown in equations Eq. (18) and Eq. (19), the worst case 2TX TRP deviation value to the average value may be predicted based on the ECC value and the two single-antenna TRP values.

Since the ECC value may be measured, calculated or determined by the six TRP values that can be measured in the OTA TRP test system 110, in some implementations, the controller 101 in the OTA TRP test system 110 may determine or configure a plurality of TPMI indices for the UE 105 to perform single-layer transmissions, wherein each TPMI index indicates a precoding matrix for a single-layer transmission. In some implementations, the controller 101 may determine or configure the TPMI indices for the UE 105 to perform single-layer transmissions, and provide the determination or configuration to the base station simulator 102. Based on the determination or configuration, the base station simulator 102 may further transmit some signaling to the UE 105 to configure or instruct the UE 105 to perform single-layer transmissions associated with the TPMI indices.

Based on the signaling received from the base station simulator 102, the UE 105 may determine or know the configuration regarding the TPMI indices to be applied in single-layer transmissions and perform the single-layer transmissions by using different precoding matrixes, wherein each precoding matrix is associated with one of the TPMI indices.

The controller 101 or the test system 110 may measure an OTA TRP of the single-layer transmission associated with each TPMI index to obtain a plurality of TRP values each associated with a TPMI index, and calculate the ECC between two antennas of the UE 105 according to the TRP values, e.g., based on the equation Eq. (16).

In some implementations, the TPMI indices for the UE 105 to perform the single-layer transmissions comprise all TPMI indices in a codebook for single-layer transmission using two antenna ports, such as the codebook shown in FIG. 2.

In some implementations, the TPMI indices comprise multiple pairs of TPMI indices with a 180 degree of phase shift, and wherein the ECC is calculated based on a variation part of the TRP values associated with the TPMI indices in each pair as in equation Eq. (16).

In some implementations, the controller 101 may determine or configure a transmission power for the single-layer transmissions. In some implementations, the controller 101 may determine or configure the transmission power for the single-layer transmissions, and provide the determination or configuration to the base station simulator 102.

In some implementations, the transmission power may be lower than a maximum transmission power limit of the UE 105 by a back-off value.

Since the 2TX TRP values may be higher than the sum of two single antenna TRP values, the transmission power may be set to the maximum transmission power with several dB (such as 3 dB) back-off to the maximum transmission power capability of the UE 105 for each antenna port to avoid the error introduced by the UE transmission power capability limit.

In some implementations, the controller 101 may determine or configure a transmission bandwidth for the single-layer transmissions as a minimum schedulable bandwidth or as a value not greater than a predetermined threshold. In some implementations, the minimum schedulable bandwidth may be one resource block (RB). In some implementations, the controller 101 may determine or configure the transmission bandwidth for the single-layer transmissions as one RB, and provide the determination or configuration to the base station simulator 102.

In some implementations, it is better to configure the transmission bandwidth as narrow as possible, such as but not limited to one RB.

In some implementations, the TPMI indices may comprise at least a pair of TPMI indices with a 180 degree of phase shift, such as the pair of TPMI indices (2, 3) and/or the pair of TPMI indices (4, 5), and the controller 101 may perform a first type of combination on the TRP values associated with the TPMI indices in the pair to obtain a common part of the TRP values (e.g., the ‘add’ operation as shown in equations Eq. (10) and Eq. (12)) and perform a second type of combination on the TRP values associated with the TPMI indices in the pair to obtain a variation part of the TRP values (e.g., the subtraction operation as shown in equations Eq. (9) and Eq. (11)), wherein the first type of combination comprises an add operation and the second type of combination comprises a subtraction operation.

In some implementations, the TPMI indices may comprise at least a first pair and a second pair of TPMI indices with a 180 degree of phase shift and a third pair of TPMI indices with a single-antenna configuration, and the controller 101 may determine a first difference between an average of the TRP values associated with the TPMI indices in the first pair and a summation of the TRP values associated with the TPMI indices in the third pair and a second difference between an average of the TRP values associated with the TPMI indices in the second pair and the summation of the TRP values associated with the TPMI indices in the third pair, and determine a capability of the UE 105 based on whether the first difference and the second difference are less than a predetermined threshold. In some implementations, the controller 101 may further determine a third difference between an average of the TRP values associated with the TPMI indices in the first pair and the second pair and the summation of the TRP values associated with the TPMI indices in the third pair, and determine a capability of the UE 105 based on whether the first difference, the second difference and the third difference are less than a predetermined threshold.

In some implementations, the controller 101 may determine whether the UE 105 is a coherent UE or not based on whether the difference is less than a predetermined threshold. In an event that the difference is less than the predetermined threshold, e.g., the average of TRP values described in equations Eq. (10) and Eq. (12) are within a certain range (as an example, 0.5 dB) relative to the sum of the two single-antenna TRP values, the UE 105 may be determined as being able to keep the phase and gain of signals stable enough on antenna ports or may be determined as a coherent UE or as having the coherent capability.

In some implementations, the controller 101 may calculate a TRP deviation value according to the ECC and the TRP values associated with the TPMI indices with the single-antenna configuration, such as the deviation value derived in equation Eq. (19). As described above, the worst case 2TX TRP deviation value to the average value may be predicted based on the ECC value and the two single-antenna TRP values.

In some implementations, the calculated or measured ECC may be provided or utilized to assist in antenna design and/or MIMO performance improvement. That is, with the information or knowledge of ECC, an inversed calculation may be implemented to obtain one or more MIMO performance parameters.

In some implementations, the controller 101 may obtain an ECC between two antennas of a communication apparatus and calculate a worst case 2TX TRP deviation value according to the ECC and a pair of TRP values associated with a single-antenna configuration according to Eq. (18).

In some implementations, for the obtaining of the ECC, the controller 101 may measure OTA TRP associated with each of a plurality of TPMI indices configured for the communication apparatus to perform single-layer transmissions to obtain a plurality of TRP values each associated with a TPMI index and calculate the ECC according to the TRP values. The TRP values comprise two pairs of TPMI indices with a 180 degree of phase shift and one pair of TRP values associated with the single-antenna configuration, and each TPMI index indicates a precoding matrix for a single-layer transmission and the TPMI indices comprise all TPMI indices in a codebook for single-layer transmission using two antenna ports.

In some implementations, the TPMI indices comprise multiple pairs of TPMI indices with a 180 degree of phase shift, and the ECC is calculated based on a variation part of the TRP values associated with the TPMI indices in each pair.

### Illustrative Implementations

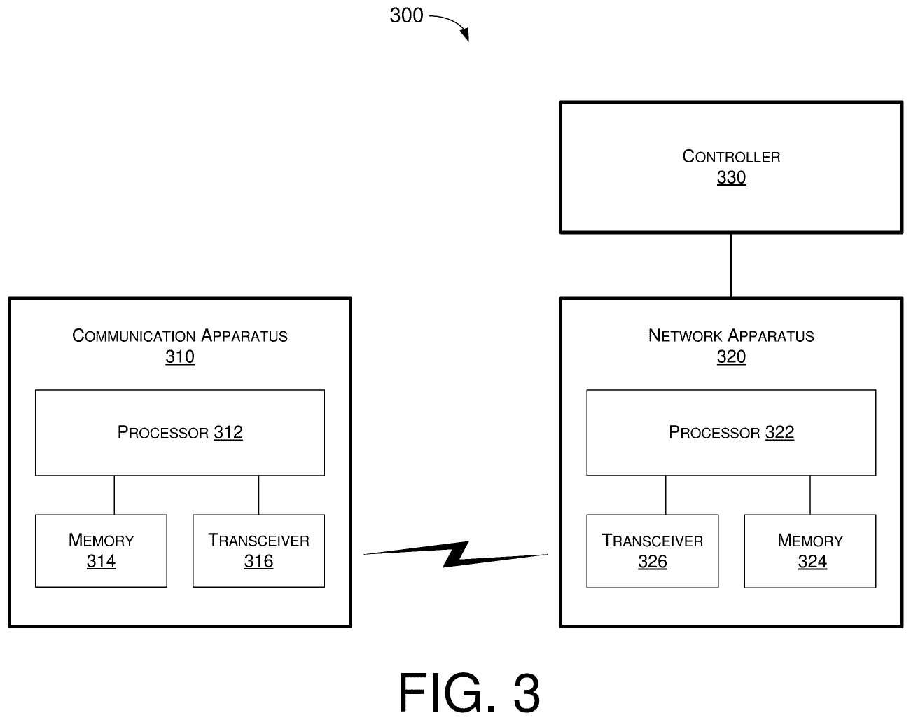

FIG. 3 illustrates an example communication system 300 having an example communication apparatus 310, an example network apparatus 320 and an example controller 330 in accordance with an implementation of the present disclosure. In some implementations, the communication apparatus 310 may be or may be a part of the UE 105 in the OTA TRP test system 110 as shown in FIG. 1, the network apparatus 320 may be or may be a part of the base station simulator 102 in the OTA TRP test system 110 as shown in FIG. 1 and the controller 330 may be or may be a part of the controller 101 in the OTA TRP test system 110 as shown in FIG. 1.

The controller 330 (e.g., accompanying with the devices in the test system 110) may perform various functions to implement schemes, techniques, processes and methods described herein pertaining to measuring or calculating the correlation between MIMO antennas with respect to communication apparatus 310 in mobile communications, including scenarios/schemes described above as well as the process 400 described below.

The communication apparatus 310 may be a part of an electronic apparatus, which may be a UE such as a portable or mobile apparatus, a wearable apparatus, a wireless communication apparatus or a computing apparatus. For instance, the communication apparatus 310 may be implemented in a smartphone, a smartwatch, a personal digital assistant, a digital camera, or a computing equipment such as a tablet computer, a laptop computer or a notebook computer. The communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 310 may be implemented in a smart thermostat, a smart fridge, a smart door lock, a wireless speaker or a home control center. Alternatively, the communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 310 may include at least some of those components shown in FIG. 3 such as a processor 312, for example. The communication apparatus 310 may further include one or more other components not pertinent to the proposed scheme of the present disclosure (e.g., internal power supply, display device and/or user interface device), and, thus, such component(s) of the communication apparatus 310 are neither shown in FIG. 3 nor described below in the interest of simplicity and brevity.

The network apparatus 320 may be a part of a network device, which may be a network node such as a satellite, a base station, a small cell, a router or a gateway. For instance, the network apparatus 320 may be implemented in a gNB in a 5G/NR, IoT, NB-IoT or IIoT network or in a satellite or base station in a 6G network. In some implementations, the network apparatus 320 may be or may be a part of or may comprise the base station simulator 102 in the OTA TRP test system 110 as shown in FIG. 1.

Alternatively, the network apparatus 320 may be implemented in the form of one or more IC chips such as, for example and without limitation, one or more single-core processors, one or more multi-core processors, or one or more RISC or CISC processors. The network apparatus 320 may include at least some of those components shown in FIG. 3 such as a processor 322, for example. The network apparatus 320 may further include one or more other components not pertinent to the proposed scheme of the present disclosure (e.g., internal power supply, display device and/or user interface device), and, thus, such component(s) of the network apparatus 320 are neither shown in FIG. 3 nor described below in the interest of simplicity and brevity.

The controller 330 may be a part of an electronic apparatus, such as a computer with an automation test tool software executed thereon and may control operations of the OTA TRP test system 110.

In one aspect, each of the processor 312 and the processor 322 may be implemented in the form of one or more single-core processors, one or more multi-core processors, or one or more CISC processors. That is, even though a singular term “a processor” is used herein to refer to the processor 312 and the processor 322, each of the processor 312 and the processor 322 may include multiple processors in some implementations and a single processor in other implementations in accordance with the present disclosure. In another aspect, each of the processor 312 and the processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and the processor 322 is a special-purpose machine specifically designed, arranged and configured to perform specific tasks including autonomous reliability enhancements in a device (e.g., as represented by the communication apparatus 310) and a network (e.g., as represented by the network apparatus 320) in accordance with various implementations of the present disclosure.

In some implementations, the communication apparatus 310 may also include a transceiver 316 coupled to the processor 312 and capable of wirelessly transmitting and receiving data. In some implementations, the communication apparatus 310 may further include a memory 314 coupled to the processor 312 and capable of being accessed by the processor 312 and storing data therein. In some implementations, the network apparatus 320 may also include a transceiver 326 coupled to the processor 322 and capable of wirelessly transmitting and receiving data. In some implementations, the network apparatus 320 may have a plurality of physical antennas which associates with a plurality of antenna ports. In some implementations, the network apparatus 320 may further include a memory 324 coupled to processor 322 and capable of being accessed by the processor 322 and storing data therein. Accordingly, the communication apparatus 310 and the network apparatus 320 may wirelessly communicate with each other via the transceiver 316 and the transceiver 326, respectively. To aid better understanding, the following description of the operations, functionalities and capabilities of each of the controller 330 is provided in the context of a mobile communication environment in which the communication apparatus 310 is implemented in or as a communication apparatus or a UE (e.g., the UE 105 in the OTA TRP test system 110), the network apparatus 320 is implemented in or as a network node or a network device (e.g., implemented in or as a base station simulator 102 in the OTA TRP test system 110) and the controller 330 may be implemented in or as the controller 101 in the OTA TRP test system 110 as shown in FIG. 1.

In some implementations, the controller 330 may measure, e.g., via the base station simulator 102 or the devices in the test system 110, an OTA TRP associated with each of a plurality of TPMI indices configured for the communication apparatus 310 to perform single-layer transmissions to obtain a plurality of TRP values each associated with a TPMI index, wherein each TPMI index indicates a precoding matrix for a single-layer transmission. The controller 330 may calculate an ECC between two antennas of the communication apparatus 310 according to the TRP values.

In some implementations, the TPMI indices that the communication apparatus 310 use to perform the single-layer transmissions may comprise all TPMI indices in a codebook for single-layer transmission using two antenna ports.

In some implementations, the TPMI indices may comprise multiple pairs of TPMI indices with a 180 degree of phase shift, and the ECC may be calculated based on a variation part of the TRP values associated with the TPMI indices in each pair.

In some implementations, the controller 330 may determine or configure a transmission power for the single-layer transmissions, wherein the transmission power is lower than a maximum transmission power limit of the communication apparatus 310 by a back-off value.

In some implementations, the controller 330 may determine or configure a transmission bandwidth for the single-layer transmissions as a minimum schedulable bandwidth or as a value not greater than a predetermined threshold.

In some implementations, the TPMI indices may comprise at least a pair of TPMI indices with a 180 degree of phase shift, and the controller 330 may perform a first type of combination on the TRP values associated with the TPMI indices in the pair to obtain a common part of the TRP values and perform a second type of combination on the TRP values associated with the TPMI indices in the pair to obtain a variation part of the TRP values, wherein the first type of combination comprises an add operation and the second type of combination comprises a subtraction operation.

In some implementations, the TPMI indices may comprise at least a first pair and a second pair of TPMI indices with a 180 degree of phase shift and a third pair of TPMI indices with a single-antenna configuration, and the controller 330 may determine a first difference between an average of the TRP values associated with the TPMI indices in the first pair and a summation of the TRP values associated with the TPMI indices in the third pair and a second difference between an average of the TRP values associated with the TPMI indices in the second pair and the summation of the TRP values associated with the TPMI indices in the third pair. The controller 330 may determine a capability of the communication apparatus 310 based on whether the first difference and the second difference are less than a predetermined threshold.

In some implementations, the TPMI indices may comprise multiple TPMI indices with a single-antenna configuration, and the controller 330 may calculate a worst case 2TX TRP deviation value according to the ECC and the TRP values associated with the TPMI indices with the single-antenna configuration.

In another aspect, the calculated or measured ECC may be provided or utilized to assist in antenna design and/or MIMO performance improvement. That is, with the information or knowledge of ECC, an inversed calculation may be implemented to obtain one or more MIMO performance parameters.

In some implementations, the controller 101 may obtain an ECC between two antennas of a communication apparatus and calculate a worst case 2TX TRP deviation value according to the ECC and a pair of TRP values associated with a single-antenna configuration.

In some implementations, for the obtaining of the ECC, the controller 101 may measure OTA TRP associated with each of a plurality of TPMI indices configured for the communication apparatus to perform single-layer transmissions to obtain a plurality of TRP values each associated with a TPMI index and calculate the ECC according to the TRP values. The TRP values comprise two pairs of TPMI indices with a 180 degree of phase shift and one pair of TRP values associated with the single-antenna configuration, and each TPMI index indicates a precoding matrix for a single-layer transmission and the TPMI indices comprise all TPMI indices in a codebook for single-layer transmission using two antenna ports.

In some implementations, the TPMI indices comprise at least a pair of TPMI indices with a 180 degree of phase shift, and the worst case 2TX TRP deviation value indicates a deviation of at least one TRP value associated with a TPMI index in the pair of TPMI indices with the 180 degree of phase shift from an average of the TRP values associated with the TPMI indices in the pair of TPMI indices with the 180 degree of phase shift, such as the relationship shown in Eq. (18).

In some implementations, the TPMI indices comprise multiple pairs of TPMI indices with a 180 degree of phase shift, and the ECC is calculated based on a variation part of the TRP values associated with the TPMI indices in each pair.

### Illustrative Processes

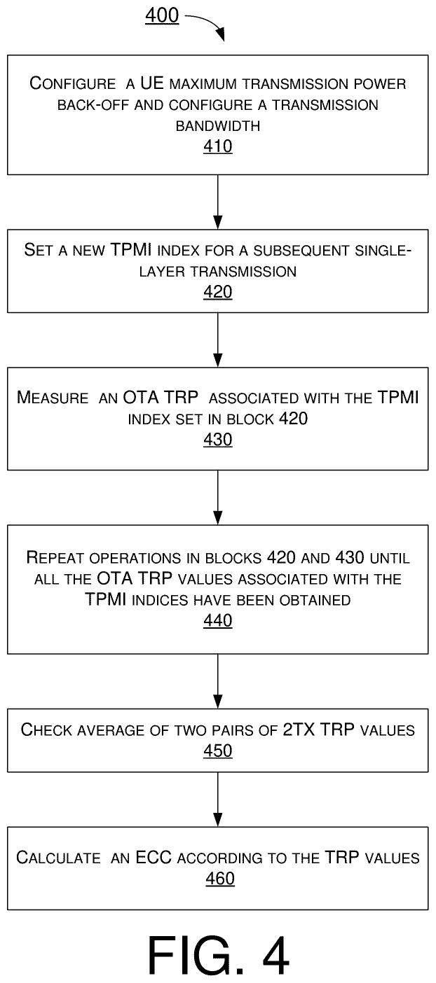

FIG. 4 illustrates an example process 400 of an OTA TRP test flow (e.g., a 3GPP 5G NR OTA TRP test flow) in accordance with implementations of the present disclosure. The process 400 may be an example implementation of above scenarios/schemes, whether partially or completely, with respect to measuring or calculating the correlation between MIMO antennas in accordance with the present disclosure. The process 400 may represent an aspect of implementation of features of operations in the OTA TRP test system 110. The process 400 may include one or more operations, actions, or functions as illustrated by one or more of blocks 410, 420, 430, 440, 450 and 460. Although illustrated as discrete blocks, various blocks of the process 400 may be divided into additional blocks, combined into fewer blocks, or eliminated, depending on the desired implementation. Moreover, the blocks of the process 400 may be executed in the order shown in FIG. 4 or, alternatively, in a different order. The blocks in process 400 may be respectively implemented by one or more devices in the OTA TRP test system 110, such as the controller 101, the base station simulator 102 and the UE 105. The process 400 may begin at block 410.

At 410, the process 400 may involve the controller 101 configuring a UE maximum transmission power value with at least 3 dB back-off to the maximum power capability limit of antenna ports of UE, and configuring a transmission bandwidth to be 1 RB in the base station simulator 102. The process 400 may proceed from 410 to 420.

At 420, the process 400 may involve the controller 101 setting the base station simulator 102 with a new TPMI index whose corresponding TRP value has not been measured yet, in 5G NR 1-layer 2-port UL-MIMO codebook according to 3GPP TS38.211 Table 6.3.1.5-1, for a subsequent single-layer transmission. In some implementations, some other parameters related to uplink configurations, such as sounding reference signals (SRS) port number, rank number, transmission mode, . . . etc., may also be set to proper values in block 420. The process 400 may proceed from 420 to 430.

At 430, the process 400 may involve the controller 101 or the test system 110 measuring an OTA TRP associated with one TPMI index configured set in block 420. The process 400 may proceed from 430 to 440.

At 440, the process 400 may involve the controller 101 repeating operations in blocks 420 and 430 until all the OTA TRP values associated with the TPMI indices as specified in 3GPP TS38.211 Table 6.3.1.5-1 have been obtained. When all the OTA TRP values have been obtained, the process 400 may proceed from 440 to 450.

At 450, the process 400 may involve the controller 101 checking the average of two pairs of 2TX TRP values. Note that the block 450 may be an optional step of an OTA TRP test flow, and the controller 101 may determine whether the UE 105 is a coherent UE or not based on average of two pairs of 2TX TRP values, such as the TRP values corresponding to the pair of TPMI indices (2, 3) and/or the pair of TPMI indices (4, 5). The process 400 may proceed from 450 to 460.

At 460, the process 400 may involve the controller 101 calculating the ECC based on the TRP values.

In some implementations, the transmission power may be lower than a maximum transmission power limit of the UE 105 by a back-off value (such as 3 dB). In some implementations, the single-layer transmissions associated with different TPMI indices may be performed by the UE 105 under the same transmission power as the one configured at block 410.

In some implementations, the transmission bandwidth may be configured as narrow as possible, such as one RB.

In some implementations, the calculated or measured ECC as the one obtained in block 430 and/or block 460 may be provided or utilized to assist in antenna design and/or MIMO performance improvement.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a controller of a test system, an over-the-air (OTA) total radiated power (TRP) associated with each of a plurality of transmit precoding matrix indicator (TPMI) indices configured for a communication apparatus to perform single-layer transmissions to obtain a plurality of TRP values each associated with a TPMI index, wherein each TPMI index indicates a precoding matrix for a single-layer transmission; and
calculating, by the controller, an envelope correlation coefficient (ECC) between two antennas of the communication apparatus according to the TRP values.

2. The method of claim 1, wherein the TPMI indices for the communication apparatus to perform the single-layer transmissions comprise all TPMI indices in a codebook for single-layer transmission using two antenna ports.

3. The method of claim 1, wherein the TPMI indices comprise multiple pairs of TPMI indices with a 180 degree of phase shift, and wherein the ECC is calculated based on a variation part of the TRP values associated with the TPMI indices in each pair.

4. The method of claim 1, further comprising:
determining, by the controller, a transmission power for the single-layer transmissions, wherein the transmission power is lower than a maximum transmission power limit of the communication apparatus by a back-off value.

5. The method of claim 1, further comprising:
determining, by the controller, a transmission bandwidth for the single-layer transmissions as a minimum schedulable bandwidth or as a value not greater than a predetermined threshold.

6. The method of claim 1, wherein the TPMI indices comprise at least a pair of TPMI indices with a 180 degree of phase shift, and wherein the method further comprises:
performing, by the controller, a first type of combination on the TRP values associated with the TPMI indices in the pair to obtain a common part of the TRP values; and
performing, by the controller, a second type of combination on the TRP values associated with the TPMI indices in the pair to obtain a variation part of the TRP values,
wherein the first type of combination comprises an add operation and the second type of combination comprises a subtraction operation.

7. The method of claim 1, wherein the TPMI indices comprise at least a first pair and a second pair of TPMI indices with a 180 degree of phase shift and a third pair of TPMI indices with a single-antenna configuration, and wherein the method further comprises:
determining, by the controller, a first difference between an average of the TRP values associated with the TPMI indices in the first pair and a summation of the TRP values associated with the TPMI indices in the third pair and a second difference between an average of the TRP values associated with the TPMI indices in the second pair and the summation of the TRP values associated with the TPMI indices in the third pair; and
determining, by the controller, a capability of the communication apparatus based on whether the first difference and the second difference are less than a predetermined threshold.

8. The method of claim 1, wherein the TPMI indices comprise multiple TPMI indices with a single-antenna configuration, and wherein the method further comprises:
calculating, by the controller, a worst case two transmission (2TX) TRP deviation value according to the ECC and the TRP values associated with the TPMI indices with the single-antenna configuration.

9. A test system, comprising:
a simulator which, during operation, wirelessly communicates with a communication apparatus; and
a controller communicatively coupled to the simulator such that, during operation, the controller performs operations comprising:
indicating the simulator a plurality of transmit precoding matrix indicator (TPMI) indices to be configured for the communication apparatus to perform single-layer transmissions; instructing the whole test system to measure an over-the-air (OTA) total radiated power (TRP) associated with each of transmit precoding matrix indicator (TPMI) indices; and
calculating an envelope correlation coefficient (ECC) between two antennas of the communication apparatus according to the TRP values.

10. The test system of claim 9, wherein the TPMI indices for the communication apparatus to perform the single-layer transmissions comprise all TPMI indices in a codebook for single-layer transmission using two antenna ports.

11. The test system of claim 9, wherein the TPMI indices comprise multiple pairs of TPMI indices with a 180 degree of phase shift, and wherein the ECC is calculated based on a variation part of the TRP values associated with the TPMI indices in each pair.

12. The test system of claim 9, wherein during operation, the controller further performs operations comprising:
determining a transmission power for the single-layer transmissions, wherein the transmission power is lower than a maximum transmission power limit of the communication apparatus by a back-off value.

13. The test system of claim 9, wherein during operation, the controller further performs operations comprising:
determining a transmission bandwidth for the single-layer transmissions as a minimum schedulable bandwidth or as a value not greater than a predetermined threshold.

14. The test system of claim 9, wherein the TPMI indices comprise at least a pair of TPMI indices with a 180 degree of phase shift, and wherein during operation, the controller further performs operations comprising:
performing a first type of combination on the TRP values associated with the TPMI indices in the pair to obtain a common part of the TRP values; and
performing a second type of combination on the TRP values associated with the TPMI indices in the pair to obtain a variation part of the TRP values,
wherein the first type of combination comprises an add operation and the second type of combination comprises a subtraction operation.

15. The test system of claim 9, wherein the TPMI indices comprise at least a first pair and a second pair of TPMI indices with a 180 degree of phase shift and a third pair of TPMI indices with a single-antenna configuration, and wherein during operation, the controller further performs operations comprising:
determining a first difference between an average of the TRP values associated with the TPMI indices in the first pair and a summation of the TRP values associated with the TPMI indices in the third pair and a second difference between an average of the TRP values associated with the TPMI indices in the second pair and the summation of the TRP values associated with the TPMI indices in the third pair; and
determining a capability of the communication apparatus based on whether the first difference and the second difference are less than a predetermined threshold.

16. The test system of claim 9, wherein the TPMI indices comprise multiple TPMI indices with a single-antenna configuration, and wherein during operation, the controller further performs operations comprising:
calculating a worst case two transmission (2TX) TRP deviation value according to the ECC and the TRP values associated with the TPMI indices with the single-antenna configuration.

17. A method, comprising:
obtaining, by a controller, an envelope correlation coefficient (ECC) between two antennas of a communication apparatus; and
calculating, by the controller, a worst case two transmission (2TX) total radiated power (TRP) deviation value according to the ECC and a pair of TRP values associated with a single-antenna configuration.

18. The method of claim 17, wherein the obtaining of the ECC further comprises:
measuring, by the controller, an over-the-air (OTA) TRP associated with each of a plurality of transmit precoding matrix indicator (TPMI) indices configured for the communication apparatus to perform single-layer transmissions to obtain a plurality of TRP values each associated with a TPMI index, wherein the TRP values comprise the pair of TRP values associated with the single-antenna configuration, and wherein each TPMI index indicates a precoding matrix for a single-layer transmission and the TPMI indices comprise all TPMI indices in a codebook for single-layer transmission using two antenna ports; and
calculating, by the controller, the ECC according to the TRP values.

19. The method of claim 18, wherein the TPMI indices comprise at least a pair of TPMI indices with a 180 degree of phase shift, and wherein the worst case 2TX TRP deviation value indicates a deviation of at least one TRP value associated with a TPMI index in the pair of TPMI indices with the 180 degree of phase shift from an average of the TRP values associated with the TPMI indices in the pair of TPMI indices with the 180 degree of phase shift.

20. The method of claim 18, wherein the TPMI indices comprise multiple pairs of TPMI indices with a 180 degree of phase shift, and wherein the ECC is calculated based on a variation part of the TRP values associated with the TPMI indices in each pair.
